(19) United States
(12) Patent Application Publication
(10) Pub. No.: US 2006/0092019 A1
(43) Pub. Date: May 4, 2006

(54) Automated diagnoses and prediction in a physical security surveillance system

(76) Inventor: Kenneth T. Fallon, Las Vegas, NV (US)

Correspondence Address: Kenneth T. Fallon, 10396 Avebury Manor Lane, Las Vegas, NV, 89135, US

(21) Appl. No.: 10/978,188

(22) Filed: Oct. 29, 2004

(51) Int. Cl. G08B 13/00

(52) U.S. Cl. 340/541

(57) ABSTRACT

An invention that automatically reports and collects security surveillance problems, device problems, device status, device diagnostics and device state information from cameras and security detection equipment. Devices may be attached to a computer network or attached through a device controller on a computer network but are not limited to only that topology. The device or the controller monitors the operation of devices and tracks any status, failures, intrusions or operational irregularities. Each detected occurrence is either recorded at the device or controller for later reporting or reported immediately to network administration centers. As much diagnostic information as possible is collected, recorded and reported. The device or the controller may also keep track of trend information and report that as well. The administration center collects the information and produces alerts and notifications as configured. These alerts and notifications may not be related to a single problem or intrusion but may be based on trend or diagnostic information. In addition the administration center analyzes the collected information and reports on intrusions, problems or other information of interest to a security system. Special charts, graphs, histogram and other reports are produced by the system to aid in proactive diagnosis, problem prediction and behavior patterns. The system produces predictive information based on trend and periodic information to alert operators of potential upcoming problems and behavior. The data and reports are available for viewing from a range of display devices that includes desktop computers (workstations and servers), laptops computers, notebook computers, cell phones, handhelds, PDAs, etc.

### BACKGROUND

### Field of Invention and Figure Description

The Automated Diagnosis and Prediction in a Physical Security Surveillance System is an invention that utilizes information collection and problem recognition to diagnose device and system information in a security surveillance system attached to cameras and detection equipment. The invention operates on computer networks and requires networked computers and surveillance equipment. The network is used to communicate between all computers and security equipment but the invention is not limited to just networked data exchange. Data may also be exchanged in any computer acceptable format if necessary. Proactive and real time diagnostic alerts, notifications and reports are produced to inform system operators and designees of network security issues. The system also produces predictive information based on trend and periodic information to alert operators of potential upcoming problems. Network attached security devices such as surveillance cameras, motions sensors, card access, bio access (retina scan, hand prints, etc.), contact sensors, detection beams, etc. are monitored by network administrative centers (a network computer) and the devices may send status updates to the network administrative centers. This collected information is processed by the administrative centers to send notifications and alerts to administrative people regarding proactive information and predictive reports on security violations, equipment operation, system operation and anticipated problems/issues. This invention provides warnings ahead of time on problems or issues within the security network. It also provides diagnostic and trend analysis reports on the operation of the security network to aid in insuring the network remains secure.

FIG. 1 shows an example of network connectivity to an enterprise security system. Users 100 have access to particular security systems 104 via a network 103 that may include the Internet, an intranet or any dedicated network.

FIG. 2 illustrates the functions provided by the diagnosis function.

FIG. 3 shows a list of supported equipment types.

FIG. 4 shows a list of possible diagnosis problems.

FIG. 5 shows sample analysis details and reports.

### DESCRIPTION OF PRIOR ART

Prior Art includes patents that set the stage for this patent and similar patents in another area (computer network intrusions). They introduce the technology that this patent leverages to produce its innovation. The following patents apply (more detail follows):
1. Intrusion alarm systems—U.S. Pat. No. 4,189,719
2. Method and apparatus for monitoring casinos and gaming—U.S. Pat. No. 6,758,751
3. Method and apparatus for detecting moving objects, particularly intrusions—U.S. Pat. No. 6,348,863
4. Dynamic software system intrusion detection—U.S. Pat. No. 6,681,331
5. Network-based alert management—U.S. Pat. No. 6,704,874
6. Features generation for use in computer network intrusion detection—U.S. Pat. No. 6,671,811
   1. Intrusion Alarm Systems—U.S. Pat. No. 4,189,719

### Abstract

An intrusion alarm system includes a microcomputer and keyboard for providing control functions for the alarm system with greater reliability and with greatly increased security as compared with prior art systems. The disclosed system provides a positive means for deactivating the alarm system only by authorized personnel by the use of a multi-digit code which must be correctly entered on the keyboard within a prescribed short period of time after entry into the protected zone. Upon entry into the protected zone, the system goes immediately into a preliminary alarm stage which, for example, may be the lighting of a floor lamp in the room. The person entering the premises then has thirty seconds to enter the correct code on the keyboard attached to the front panel of the alarm unit to deactivate the system. If an unauthorized person enters and cannot provide the required code, the system enters the final alarm stage which turns on the automatic dialer to notify the police and also turns on auxiliary sirens, outdoor lights, and any other alarm outputs that may be desired.

2. Method and Apparatus for Monitoring Casinos and Gaming—U.S. Pat. No. 6,758,751

### Abstract

A system automatically monitors playing and wagering of a game. A card deck reader automatically reads a symbol identifying a respective rank and suit of each card in a deck before a first cards is removed. A chip tray reader automatically images the contents of a chip tray for verifying that proper amounts have been paid out and collected. A table monitor automatically images the activity occurring at a gaming table. Periodic comparison of the images identifies wagering, as well as the appearance, removal and position of cards and other game objects on the gaming table. The system detects prohibited playing and wagering patterns, and determines the win/loss percentage of the players and the dealer, as well as a number of other statistically relevant measures. The measurements provide automated security and real-time accounting.

3. Method and Apparatus for Detecting Moving Objects, Particularly Intrusions—U.S. Pat. No. 6,348,863

### Abstract

A method and apparatus for detecting for detecting intrusions, such as intrusions through a door or window of a room, in a manner which ignores movements in other adjacent regions, is provided. The method of detecting intrusions with respect to a monitored space includes exposing the monitored space to a passive infrared sensor having a first sensor element generating a positive polarity signal when its field of view senses an infrared-radiating moving object, and a second sensor element generating a negative polarity signal when its field of view senses an infrared-radiating moving object; generating a movement signal consisting of a positive polarity signal and a negative polarity signal when both have been generated within a first time interval such as to indicate the movement of an object within the monitored space; determining from the relative sequential order of the positive polarity signal and negative polarity signal in the movement signal the direction of movement of the detected object, and particularly whether the movement direction is a hostile direction or a friendly direction; and actuating an alarm when the direction of movement of the movement signal is determined to be in the hostile direction, but not when it is determined to be in the friendly direction.

4. Dynamic Software System Intrusion Detection—U.S. Pat. No. 6,681,331

### Abstract

A real-time approach for detecting aberrant modes of system behavior induced by abnormal and unauthorized system activities that are indicative of an intrusive, undesired access of the system. This detection methodology is based on behavioral information obtained from a suitably instrumented computer program as it is executing. The theoretical foundation for the present invention is founded on a study of the internal behavior of the software system. As a software system is executing, it expresses a set of its many functionalities as sequential events. Each of these functionalities has a characteristic set of modules that is executed to implement the functionality. These module sets execute with clearly defined and measurable execution profiles, which change as the executed functionalities change. Over time, the normal behavior of the system will be defined by the boundary of the profiles. An attempt to violate the security of the system will result in behavior that is outside the normal activity of the system and thus result in a perturbation of the system in a manner outside the scope of the normal profiles. Such violations are detected by an analysis and comparison of the profiles generated from an instrumented software system against a set of known intrusion profiles and a varying criterion level of potential new intrusion events.

5. Network-Based Alert Management—U.S. Pat. No. 6,704,874

### Abstract

A method of managing alerts in a network including receiving alerts from network sensors, consolidating the alerts that are indicative of a common incident and generating output reflecting the consolidated alerts.

6. Features Generation for Use in Computer Network Intrusion Detection—U.S. Pat. No. 6,671,811

### Abstract

Detecting harmful or illegal intrusions into a computer network or into restricted portions of a computer network uses a features generator or builder to generate a feature reflecting changes in user and user group behavior over time. User and user group historical means and standard deviations are used to generate a feature that is not dependent on rigid or static rule sets. These statistical and historical values are calculated by accessing user activity data listing activities performed by users on the computer system. Historical information is then calculated based on the activities performed by users on the computer system. The feature is calculated using the historical information based on the user or group of users activities. The feature is then utilized by a model to obtain a value or score which indicates the likelihood of an intrusion into the computer network. The historical values are adjusted according to shifts in normal behavior of users of the computer system. This allows for calculation of the feature to reflect changing characteristics of the users on the computer system.

None of the patents above offer the solution presented in this invention and most are related to computer virus intrusions and not physical surveillance systems. The concept of managing security surveillance systems is new and is especially useful in law enforcement and guard agencies. The concept in this invention of using diagnostic and status information from physical security devices to report on network problems, trends and predictive behavior is uniquely new. By using the invention users are able to better manage and predict security issues in a network based physical security system.

### DETAILED DESCRIPTION

Embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured on in terms of the claims.

Network Security System Information Collection and Reporting:

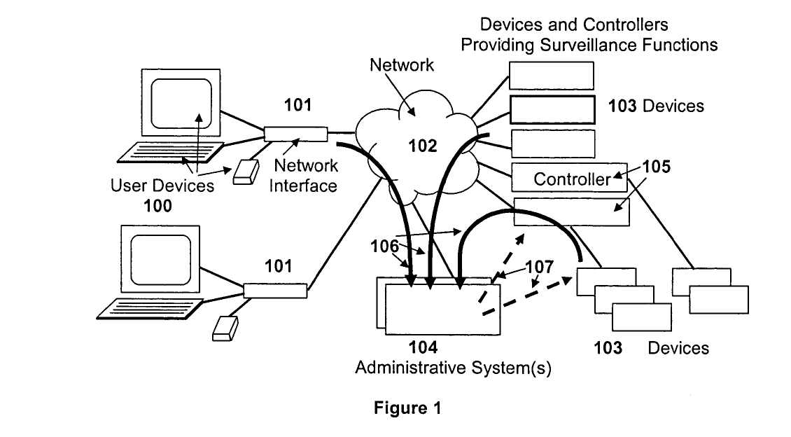

The invention consists of three main functions; collecting information from physical security devices, analyzing the information and reporting the results to users and administrators. FIG. 1 shows an example of network connectivity to an enterprise security system that can use the invention. This illustrates the method of information collection which consists of the administrative center computers requesting information from devices or control units, running diagnostics on devices or control units, or receiving dynamic messages from devices or control units.
1. User devices 100 command and control the security monitoring system 104 and its devices 103. These devices may be a desktop computer, an Internet access computer, a cell phone, a handheld device, a PDA, etc. These are used to receive diagnostic and predictive information from the administrative center. They may also request information from the administrative center or directly from devices or control units.
2. The commands from the user devices come across network 101 which normally is a wireless (but not limited to wireless) network that interfaces to a backbone network 102 which may be the Internet, intranet or any dedicated type network.
3. Information exchange takes place between users 100, the security devices 103, and the security administrative center 104 controlling the flow across networks 101 and 102, producing predictive reports and delivering critical information to users.
4. The System Administrative Centers 104 receive dynamic information from device and control units via path 106. The administrative centers also request information from device and control units via path 107 and answers are returned via path 106.
5. Information and reports are sent to user devices 101 via the network.

Diagnosis Functions and Results:

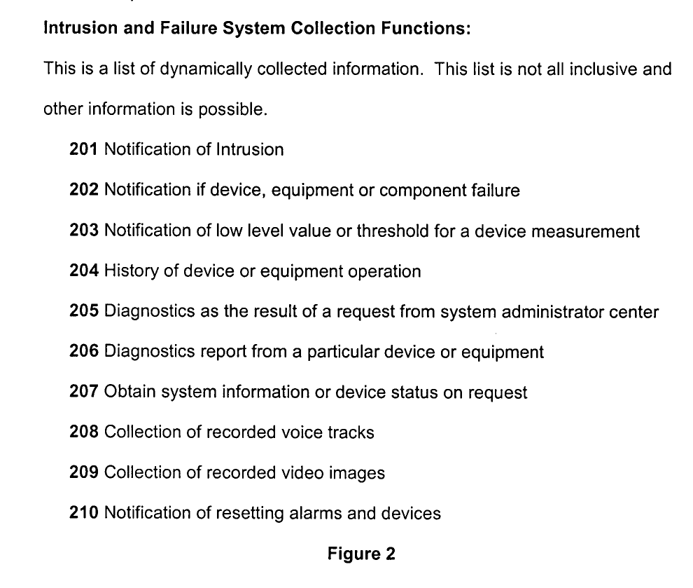

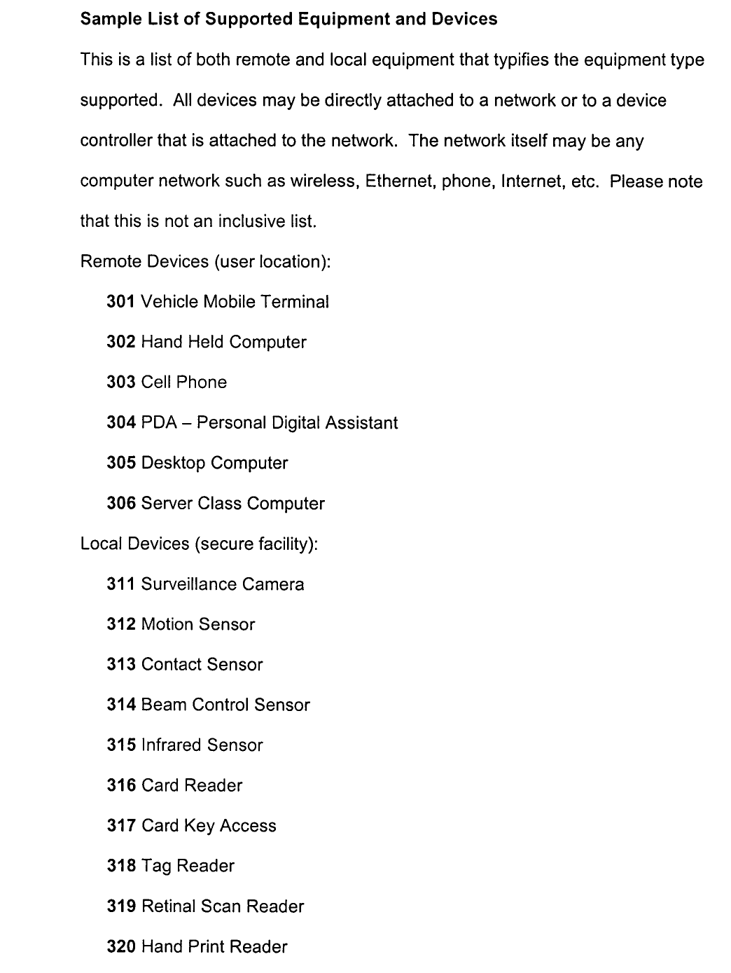

After collecting security information the next step is to analyze this information and produce diagnostic and predictive results. FIG. 2 illustrates sample collected information by the diagnosis function. This is the process that takes place at the administrative computer centers and the results are sent to user information via user display devices. The information is in the form of alerts, notifications or reports. 201 through 210 list possibilities.

### SUPPORTED DEVICES/EQUIPMENT EXAMPLES

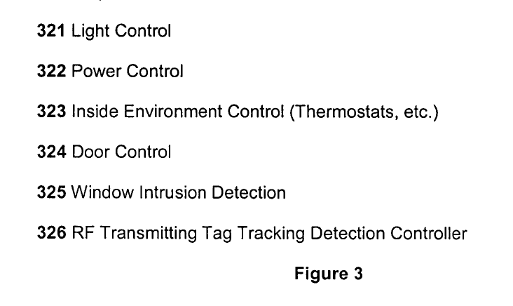

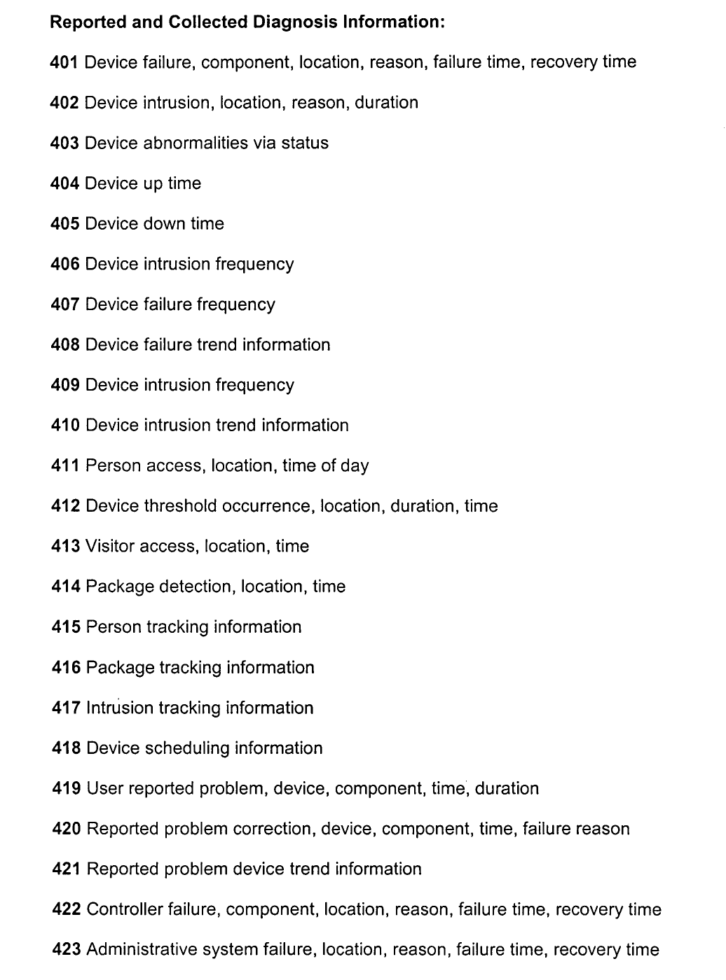

In order to be effective the invention needs to support a wide range of security devices on both the user display side and the security detection side. FIG. 3 shows a list of supported device/equipment types that may be attached to a security network directly or through a device controller. Items 301 through 326 give a list of the devices that include user display devices. The invention is broader than this list and it is not limited to the list contents.

Diagnoses Problems:

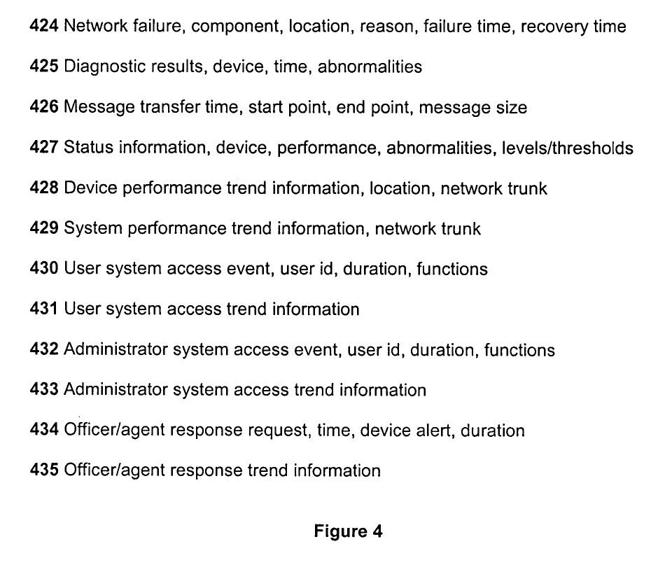

In order to diagnose issues and produce reports specific diagnostic information needs to be collected and categorized. FIG. 4 shows a list of possible diagnosis issues that lead to information collection. Items 401 through 435 present various diagnosis results and collection information. This list does not include all possible diagnosis.

### ANALYSIS EXAMPLES

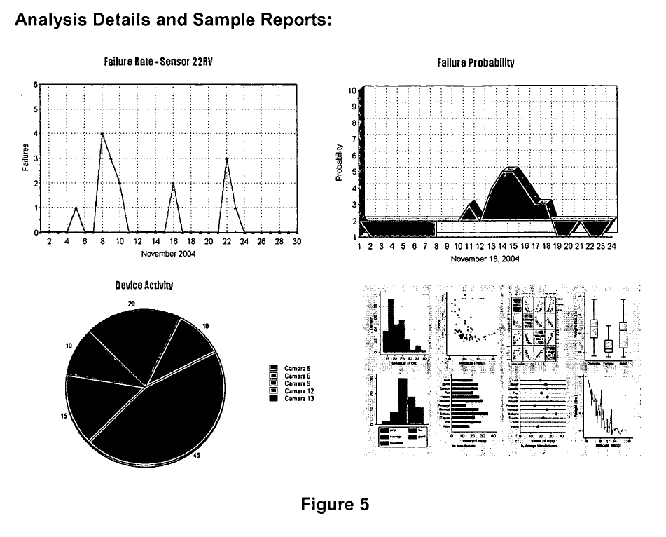

FIG. 5 shows some analysis details with sample reports.

What is claimed is:

1. The invention has security surveillance devices such as cameras and detection equipment that are attached to a network, attached to a device controller unit on a network, or attached via any electronic means. Devices or the control units automatically report problems and status to administrative computers. The reported information is saved to be analyzed to determine the reason for the problem/issue, the frequency of the problem/issue, the severity of the problem/issue and potential future problems/issues with the device. The diagnosis is not limited to just these results but may also present trends and predictive behavior.
i. Devices include but are not limited to detection and surveillance equipment such as cameras, power control units, motion sensors, contact sensors, card readers, people identifying units (retinal scan, etc.), lighting control, motion control, access identification units; and include user display equipment such as desktop computers (workstations or servers), laptop computers, mobile vehicle terminals, hand held computers, cell phones, PDAs, and all similar remote devices.
ii. Analysis results are hardware failure, feature failure, network failure, operation error, human error, equipment misuse, intermittent error, externally activated error, repeated intrusions, trend information, predictive behavior, etc.
iii. The remote detection or surveillance device or a remote control unit detect the error or problem condition gather information and report it to administrative centers using a computer network or some other electronic means. Other methods like file transfer or printed outputs may be used to transfer the information as well. Administrative centers to be informed are configured as part of system setup.
iv. Administrative software centers gather the notification information from the devices or control units and save it for analysis.

2. A system that performs detailed analysis of collected surveillance security information from cameras or detection equipment to analyze problems, failures, warnings, notifications, trends, or predictive behavior. This analyzed information is reported to selected or requesting users attached to a computer network or electronically from user display devices (desktop computers, laptop computers, mobile vehicle terminals, hand held computers, cell phones, PDAs, and all similar remote devices).
i. After gathering information the invention runs special analysis software at administrative centers against this gathered data to identify failure trends and behavior. This software identifies problem areas and recommends corrective action.
ii. Special reports are generated by the invention to identify failure or problem areas in the network attached security equipment. These reports are used to assist in correction of identified problems.
iii. The invention produces graphs and charts of problem trends to help identify problem areas and predict behavioral or suspicious activity.
iv. Administrative software periodically, on demand or by triggers, investigate the reported problems and produce a report, send out notifications, send out warnings, invoke alarms, or log the results of the problem analysis.
